(19) United States
(12) Patent Application Publication
(10) Pub. No.: US 2026/0002069 A1
(43) Pub. Date: Jan. 1, 2026

(54) CONTROLLABLE ASYMMETRIC SURFACE FUNCTIONALIZATION OF NANOMATERIALS WITH NATURAL POLYMER TEMPLATE

(71) Applicant: SAUDI ARABIAN OIL COMPANY, Dhahran (SA)

(72) Inventor: Wei Wang, Quincy, MA (US)

(73) Assignee: ARAMCO SERVICES COMPANY, Houston, TX (US)

(21) Appl. No.: 18/758,431

(22) Filed: Jun. 28, 2024

(51) Int. Cl. C09K 8/58

(52) U.S. Cl. CPC C09K 8/58; C09K 2208/10

(57) ABSTRACT

A method of preparing Janus nanomaterials includes dispersing a chitosan template in an aqueous solution, adsorbing a first portion of a surface of a nanomaterial on the chitosan template, functionalizing a second portion of the surface of the nanomaterial so that the second portion includes a hydrophobic surface functionality, and releasing the nanomaterial from the chitosan template, thereby providing the nanomaterial with asymmetric surface functionalities where the first portion includes a hydrophilic surface functionality and the second portion includes the hydrophobic surface functionality. A method also includes introducing an enhanced oil recovery fluid including Janus nanomaterials from a chitosan template so that the Janus nanomaterials include a hydrophilic surface functionality and a hydrophobic surface functionality, displacing hydrocarbons from the hydrocarbon-bearing formation after introducing the enhanced oil recovery fluid with the Janus nanomaterials, and recovering the hydrocarbons.

### BACKGROUND

Among the major challenges in the modern world, meeting energy needs and protecting the environment are two of the top ranked. In addressing our ever-growing energy needs, conventional fossil fuels are still the primary energy source; however, they are becoming harder to extract from mature fields. Recent developments in petroleum engineering research have shown that nanomaterials may be used in water flooding techniques in oilfields, often referred to as nanofluid flooding, to improve oil displacement. One advantage of nanofluids arises from the small size of the included nanomaterials, that are able to alter the wettability of the reservoir rocks and/or change interfacial tension (IFT) at water-oil interface to increase oil recovery. However, various constraints influence the fluid-fluid and fluid-rock interactions of current nanofluids and subsequent oil recovery.

Janus nanomaterials are types of nanomaterials with at least two surfaces having different respective physical properties. This surface arrangement of Janus nanomaterials allows two different types of chemistry to occur on the same material. This surface configuration gives properties related to the asymmetric structure or asymmetric functionalization of the materials. The broken symmetry offers efficient and distinctive means to target complex self-assembled materials and realize the emergence of properties that are presently inconceivable for homogeneous materials or symmetric patchy materials.

Janus nanomaterials have many remarkable properties but are difficult to produce in large quantities. The synthesis of Janus nanomaterials tends to rely on selectively creating each side of a material with at least one dimension on the nanoscale with different chemical properties. Example syntheses of Janus nanomaterials include masking, self-assembly, and phase separation. Janus nanomaterials have been produced in the laboratory scale and typically employ multiple-step reactions. Most of the developed methods are unable to produce Janus nanomaterials economically for industrial applications, therefore, new methods for mass production of Janus nanomaterials are highly desired.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method of preparing a Janus nanomaterial. The method may include dispersing a chitosan template in an aqueous solution, adsorbing a first portion of a surface of a nanomaterial on the chitosan template, functionalizing a second portion of the surface of the nanomaterial so that the second portion includes a hydrophobic surface functionality, and releasing the nanomaterial from the chitosan template, thereby providing the nanomaterial with asymmetric surface functionalities where the first portion includes a hydrophilic surface functionality and the second portion includes the hydrophobic surface functionality.

In another aspect, embodiments disclosed herein relate to a method of enhanced oil recovery. The method may include introducing an enhanced oil recovery fluid into a hydrocarbon-bearing formation, where the enhanced oil recovery fluid includes Janus nanomaterials. The Janus nanomaterials may be prepared using a chitosan template so that the Janus nanomaterials include a hydrophilic surface functionality and a hydrophobic surface functionality. The method may include displacing hydrocarbons from the hydrocarbon-bearing formation after introducing the enhanced oil recovery fluid with the Janus nanomaterials and recovering the hydrocarbons.

Other aspects and advantages of the claimed subject matter will be apparent from the following description and the appended claims.

### BRIEF DESCRIPTION OF DRAWINGS

FIG. 1 is a block-flow diagram of a method in accordance with one or more embodiments of the present disclosure.

FIG. 2 is a schematic illustration of a method in accordance with one or more embodiments of the present disclosure.

FIG. 3 is a schematic illustration of a well environment in accordance with one or more embodiments of the present disclosure.

FIG. 4 is a block-flow diagram of a method in accordance with one or more embodiments of the present disclosure.

FIG. 5A is an image of adsorbed nanomaterials on the chitosan template in accordance with one or more embodiments of the present disclosure.

FIG. 5B is an image of Janus nanomaterials in a water-organic solvent in accordance with one or more embodiments of the present disclosure.

FIGS. 6A-D are Langmuir isotherms of Janus nanomaterials in accordance with one or more embodiments of the present disclosure.

### DETAILED DESCRIPTION

Recent developments in enhanced oil recovery (EOR) techniques have demonstrated the effective use of nanotechnology in EOR fluids to improve oil recovery. Generally, nanomaterials included in EOR fluid can resist high temperature and pressure in subsurface oil reservoir system and exhibit different surface properties compared to organic molecules in porous media such as reservoir rocks, providing access to oil that is unreachable by surfactants and polymers conventionally used in EOR processes. Based on the specific physical characteristics and properties of a given nanomaterial, additional benefits of using such technology may include the ability to alter the wettability of minerals, decrease the interfacial tension (IFT) at the oil-water interface, change the viscosity of fluids, and/or generate structural disjoining pressure at the oil/rock interface. Specifically, Janus nanomaterials whose surfaces have two or more distinct chemical or physical properties, hold dual nanoparticle and surfactant-like properties. Accordingly, the development of economical and sustainable methods to produce field quantities of low-cost nanomaterials would be very beneficial.

Chitosan, a natural polymer, is a linear polysaccharide composed of randomly distributed β-(1→4)-linked D-glucosamine (deacetylated unit) and N-acetyl-D-glucosamine (acetylated unit). Chitosan is commercially made by treating chitin with an alkaline substance (e.g., sodium hydroxide). Chitin is a main component in the shells of crustaceans as well as insect exoskeletons, fish scales, and in the cell walls of fungi. The structure of chitosan includes amine groups which may be protonated or deprotonated, depending on the pH of the solution the chitosan is dispersed in. For example, if the pH is greater than or equal to 6.3, the amine groups will be deprotonated. In contrast, if the pH is less than 6.3, the amine groups will be protonated. Finally, if the pH is less than or equal to 4.5, the amine groups will be fully protonated. When the amine groups are protonated, chitosan becomes soluble in aqueous solutions. Thus, chitosan is known to be fully dissolved in aqueous solutions with a pH of 4.5 or less, soluble in aqueous solutions with a pH of less than 6.3, and insoluble in aqueous solutions with a pH greater than or equal to 6.3. This unique property of chitosan makes chitosan useful as a template for preparing Janus nanomaterials. Accordingly, the present disclosure relates to a method of preparing Janus nanomaterials using chitosan as a template, as well as a method of EOR using such Janus nanomaterials.

In one aspect, embodiments disclosed herein relate to a method of preparing Janus nanomaterials. In particular, the Janus nanomaterials may be prepared using chitosan as a template where the nanomaterials may include nanoparticles, nanotubes, or nanosheets. The method may include adsorbing a first portion of the surface of the nanomaterials onto a chitosan template, such that a hydrophilic surface functionality is adsorbed onto the chitosan template. Then, the method may include functionalizing a second portion of the surface with a chemical agent such that a hydrophobic surface functionality is functionalized on the second portion of the surface. The method may then include releasing the nanomaterial from the chitosan template, thus releasing a Janus nanomaterial with asymmetric surface functionalities.

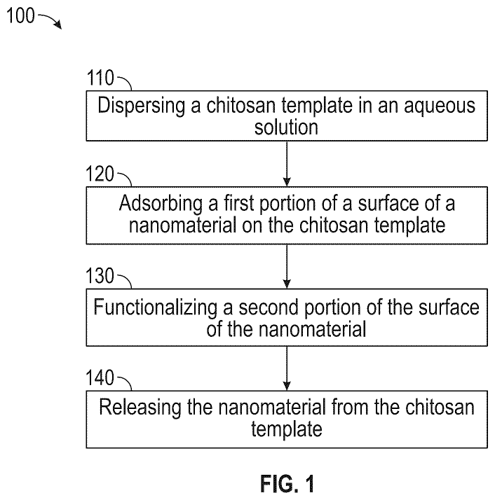

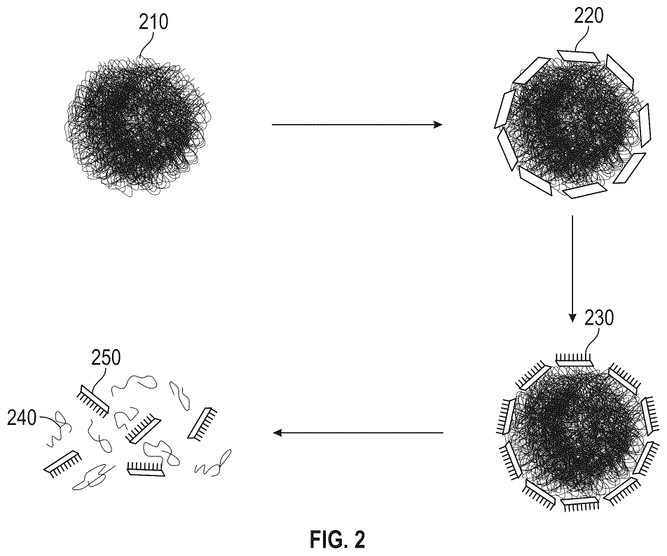

A method 100 for preparing a Janus nanomaterial in accordance with one or more embodiments is shown in FIG. 1 and further discussed in FIG. 2. Initially, method 100 at block 110 includes dispersing a chitosan template in an aqueous solution. The chitosan template may be from any known commercial source of chitosan, such as Thermo Fisher Scientific, TCI Chemicals, Spectrum Chemical, MP Biomedicals, Sigma-Aldrich, or Matexcel. In one or more embodiments, block 110 includes dispersing the chitosan template in an aqueous solution in which the pH is from 6.5 to 9.5. As such, the chitosan template may be deprotonated chitosan. This pH leads to the chitosan template not being soluble in the aqueous solution. The chitosan template may be from a powdered form of chitosan. The chitosan powder may have an average particle size of 10 to 100 microns.

FIG. 2, according to one or more embodiments, depicts a method for preparing a Janus nanomaterial. As illustrated in FIG. 2, the chitosan template 210 is aggregated polymer chains of deprotonated chitosan which are not soluble in the aqueous solution. The aqueous solution may include deionized water. The pH of the deionized water may be adjusted using a base. The base for adjusting the pH may be sodium hydroxide, potassium hydroxide, or ammonium hydroxide. A sufficient amount of base may be added to achieve the required pH as explained above. The amount of chitosan added to the aqueous solution may be a quantity sufficient to allow for absorption of all the nanomaterials onto the chitosan surface, without a leftover suspension of free unabsorbed nanoparticles. After dispersing the chitosan template in the aqueous solution, the nanomaterials may be added to the aqueous solution and mixed by sonication or stirring. The amount of chitosan may be sufficient when in a standing suspension, the chitosan particles with the nanomaterials settle down from the aqueous solution as sediment in 1-3 minutes and the resulting supernatant is clear (i.e., without suspended free nanomaterials). More chitosan may need to be added if the resulting supernatant is not clear. The weight ratio of the chitosan template to nanomaterials may be from 1:0.0001 to 1:0.01 to 0.01:1, depending on different nanomaterials. The absorption of chitosan may be achieved through sonication or stirring.

Method 100 at block 120 includes adsorbing a first portion of a surface of a nanomaterial on the chitosan template. The nanomaterial may include 0-dimensional nanoparticles, 1-dimensional nanotubes, 2-dimensional nanosheets, and combinations thereof. As used herein, “0-dimensional nanoparticles” are particles with all dimensions under 100 nanometers (nm). Examples may include spherical superparamagnetic iron oxide (Fe₃O₄) nanoparticles; metal oxide nanoparticles including iron (III) oxide (Fe₂O₃) nanoparticles, silicon dioxide (SiO₂) nanoparticles, titanium dioxide (TiO₂) nanoparticles, zinc oxide (ZnO) nanoparticles, aluminum oxide (Al₂O₃) nanoparticles, zirconium dioxide (ZrO₂) nanoparticles; metal nanoparticles including silver (Ag) nanoparticles, gold (Au) nanoparticles, palladium (Pd) nanoparticles, platinum (Pt) nanoparticles, ruthenium (Ru) nanoparticles, rhodium (Rh) nanoparticles, iron (Fc) nanoparticles, cobalt (Co) nanoparticles, nickel (Ni) nanoparticles, copper (Cu) nanoparticles; or metal chalcogenide nanoparticles including zinc sulfide (ZnS), cadmium sulfide (CdS), copper monosulfide (CuS), mercury sulfide (HgS), zinc selenide (ZnSe), cadmium selenide (CdSe), zinc telluride (ZnTe), cadmium telluride (CdTe), either produced in a lab or commercially procured from various suppliers.

As used herein, “1-dimensional nanomaterials” are tubes, rods, wires or belts having a diameter from 1 to 100 nm, with an aspect ratio from 10 to 100. Examples may include multiwalled carbon nanotubes, single-walled carbon nanotubes, TiO₂ nanowires, metal nanorods or nanowires (Ag, Au), quantum nanorods (ZnS, CuS, CdS, ZnSe, CuSe, CdSe, ZnTe, CuTe, CdTe), and oxide nanobelts (ZnO, TiO₂, SnO₂, CeO₂, WO₃).

As used herein, “2-dimensional nanosheets” are composed of thin layers having a thickness from 1 to 100 nm, while the width can be from 10 nm to 100 μm. Examples may include graphene nanosheets, molybdenum sulfide nanosheets, and metal nanosheets (Cu, Ag, Au, Pd, Pt).

As illustrated in FIG. 2, the first portion of the surface of the nanomaterial 220 is adsorbed onto the chitosan template 210. The adsorption may occur by hydrogen bonding or through Van der Waals forces between the first portion of the surface of the nanomaterial and the chitosan template. As such, the nanomaterial 220 must have a suitable hydrophilic surface functionality in order to adsorb onto the chitosan template 210. For example, in one or more embodiments, the nanomaterial 220 may adsorb onto chitosan and may have hydroxyl groups on the surface of the chitosan. This may allow for further functionalization through covalent chemical bonding. The adsorption mechanism may include electrostatic interaction or van der Waal interaction. The nanomaterial 220 may be added to the dispersion of the chitosan template 210 at an amount sufficient to allow for formation of a monolayer on the chitosan surface. After the addition of the nanomaterials, the chitosan with adsorbed nanomaterials may settle out and leave a clear supernatant in a period of 1 to 3 minutes. If a clear supernatant does not result in this period, more chitosan may need to be supplied for further adsorption until a clear supernatant is reached. The clear supernatant may indicate that no unabsorbed nanomaterials are suspended. After the nanomaterial is added, the solution may be stirred or sonicated for several minutes up to several hours to ensure complete adsorption. After adsorption of the nanomaterial onto the chitosan template, the dispersion may be filtrated or centrifuged to separate solid nanomaterial from the liquid medium. The dispersion may then be rinsed with DI water or solvents such as methanol to remove any nanomaterials that are not adsorbed.

Method 100 at block 130 includes functionalizing a second portion of the surface of the nanomaterial. In this step, a chemical agent may be attached to the second portion of the surface of the nanomaterial. The chemical agent includes a reactive group capable of grafting to the nanoparticle surface and also a hydrophobic group that ultimately provides a hydrophobic surface functionality on the second portion of the nanomaterial. Chemical agents may include silane coupling agents having a hydrophobic functional group. The silane coupling agent may be any molecule that follows formula (I) below.

$${( {R}^{I} O )}_{3} - Si - {OR}^{II} \qquad ( I )$$

R^{I} is —(CₙH₂ₙ₊₁)₃, n=1-4; and R^{II} is —(CH₂)ₘ—CH₃, m=7-17; —(CH₂)ₚ—NH₂, p=7-17; cycloalkyl, heteroaryl, alkoxy, aminoacyl, cycloalkenyl, heteroaryloxy, heterocyclooxy, and combinations thereof. Specific examples of the chemical agent include, but are not limited to octadecyltriethoxysilane (OTES), dodecyltriethoxysilane (DTES), p-Tolyltriethoxysilane (p-TTES), and 1H, 1H,2H,2H-Perfluorooctyltriethoxysilane (PFOTES). The hydrophobic surface functionality is provided by R^{II} in formula (I), above, and therefore, may include alkyl, alkylamine, cycloalkyl, heteroaryl, alkoxy, aminoacyl, cycloalkenyl, heteroaryloxy, and heterocyclooxy groups. The chemical agent may be added at a weight ratio of 0.01:1 to 1:1 of the nanomaterial.

As illustrated in FIG. 2, the second portion of the surface of the nanomaterial 220 is functionalized with a hydrophobic surface functionality 230. The functionalization may occur through a reaction between the chemical agent and the second portion of the surface of the nanomaterial 220. The chemical agent includes a hydrophobic functional group that provides the hydrophobic surface functionality 230. For example, with regards to a silane coupling agent, the silane coupling agent is added to the dispersed chitosan template with the first portion of the surface of the nanomaterial adsorbed. Under basic conditions of a pH of 9 to 10, the silane group of the coupling agent reacts with a hydroxide group present on the second portion of the surface of the nanomaterial. The silane coupling agent is used in a molar excess to ensure complete functionalization. As the hydrophobic surface functionality is provided by the silane coupling agent, the reaction of the silane coupling agent results in the functionalization of the second surface of the nanomaterial with the hydrophobic surface functionality. The nanomaterials may then be separated from the liquid medium by filtration or centrifugation.

Method 100 at block 140 includes releasing the nanomaterial from the chitosan template. When released, the first portion of the surface of the nanomaterial may be desorbed from the chitosan template. As such, the hydrophilic surface functionality may be desorbed from the chitosan template. Thus, releasing the nanomaterial from the chitosan template may provide a Janus nanomaterial where the first portion of the surface has a hydrophilic surface functionality, and the second portion of the surface has a hydrophobic surface functionality.

As illustrated in FIG. 2, releasing the nanomaterial from the chitosan template results in the now asymmetrically functionalized Janus nanomaterial 250 being dispersed in the aqueous solution. Releasing the nanomaterial from the chitosan template may occur through changing the pH of the aqueous solution to be less than 4.5, and in some particular embodiments, a pH between 1 and 3. A pH of less than 4.5 in the aqueous solution will protonate the amines on the chitosan, as discussed above. The protonated chitosan 240 may now be soluble in the aqueous solution. The pH of the aqueous solution may be adjusted by an addition of acid to the solution. The acid may be hydrochloric acid, or acetic acid. In one or more embodiments, the dissolution of the chitosan template into the aqueous solution releases the first portion of the surface of the nanomaterial from the chitosan template. The nanomaterial may now be asymmetrically functionalized. Asymmetric surface functionalities of the nanomaterial may include the first portion of the surface having a hydrophilic surface functionality and the second portion of the surface having a hydrophobic surface functionality.

As described above, Janus nanomaterials in accordance with the present disclosure have a hydrophilic surface and a hydrophobic surface. As such, the disclosed Janus nanomaterials may have unique properties, such as surfactant-like surface properties. For example, as characterized according to Langmuir isotherm, the present Janus nanomaterials may exhibit an adsorption similar to that of conventional surfactants. Surfactants are widely used in enhanced oil recovery for their dual hydrophobic and hydrophilic nature. Accordingly, Janus nanomaterials of one or more embodiments may be beneficial to EOR processes when incorporated in EOR fluid compositions.

Embodiments disclosed herein also relate to a composition for EOR. The composition may include a nanomaterial and an aqueous-based fluid. In one or more embodiments, the nanomaterial in the EOR composition is the carbon nanoparticles described above.

The EOR composition may include the Janus nanomaterials in an amount ranging from about 0.001 wt % (weight percent) to about 3.0 wt % based on the total weight of the EOR composition. For example, in one or more embodiments, Janus nanomaterials are present in the EOR nanofluid in an amount ranging from a lower limit of one of 0.001, 0.005, 0.01, 0.05, and 0.1 wt % to an upper limit of one of 0.5, 1.0, 1.5, 2.0, 2.5, and 3.0 wt %, where any lower limit may be paired with any mathematically compatible upper limit.

In one or more embodiments, the EOR composition includes an aqueous-based fluid. The aqueous-based fluid includes water. The water may be distilled water, deionized water, tap water, fresh water from surface or subsurface sources, production water, formation water, natural and synthetic brines, brackish water, natural and synthetic sea water, black water, brown water, gray water, blue water, potable water, non-potable water, other waters, and combinations thereof, that are suitable for use in a wellbore environment. In one or more embodiments, the water used may naturally contain contaminants, such as salts, ions, minerals, organics, and combinations thereof, as long as the contaminants do not interfere with the operation of the drilling fluid.

In one or more embodiments, the EOR composition includes water in a range of from about 97 wt % to 99.9 wt % based on the total weight of the EOR composition. In one or more embodiments, the water used for the EOR composition may have an elevated level of salts or ions versus fresh water, such as salts or ions naturally present in formation water, production water, seawater, and brines. Without being bound by any particular mechanism or theory, increasing the saturation of water by increasing the salt concentration or other organic compound concentration in the water may increase the density of the water, and thus, the EOR composition. Suitable salts may include, but are not limited to, alkali metal halides, such as chlorides, hydroxides, or carboxylates. In one or more embodiments, salts included as part of the aqueous-based fluid may include salts that disassociate into ions of sodium, calcium, cesium, zinc, aluminum, magnesium, potassium, iron, copper, strontium, silicon, lithium, chlorides, bromides, carbonates, iodides, chlorates, bromates, formates, nitrates, sulfates, phosphates, hydroxides, and fluorides, and combinations thereof.

In one or more embodiments, the EOR composition includes one or more salts in an amount that ranges from about 0 to about 225,000 ppm (parts per million) in TDS (total dissolved solids). For example, the EOR composition may contain the one or more salts in an amount ranging from a lower limit of any of 0, 5,000, 10,000, 20,000, 30,000, 50,000, 75,000, 100,000 and 125,000 ppm to an upper limit of any of 125,000, 150,000, 175,000, 200,000, and 225,000 ppm, where any lower limit can be used in combination with any mathematically compatible upper limit.

In one or more embodiments, the EOR composition includes one or more additives. Any additives known in the art for EOR compositions may be used. Examples of such additives include but are not limited to surfactants, polymers, stabilizers, and/or mixtures thereof. In one or more embodiments, additives may be included in the EOR composition in an amount ranging from 0 to about 3 wt % based on the total weight of the EOR composition.

In one or more embodiments, the EOR nanofluid may be characterized according to several properties, such as, for example, viscosity, density, and homogeneity. Further, the presence of the carbon nanoparticles in the fluid may result in a decreased interfacial tension between the EOR fluid and the oil within a reservoir.

In another aspect, embodiments of the present disclosure relate to a method of enhanced oil recovery using an enhanced oil recovery composition described above. The method may include introducing an enhanced oil recovery composition into a hydrocarbon-bearing formation, displacing hydrocarbons from the hydrocarbon-bearing formation, and recovering the hydrocarbons.

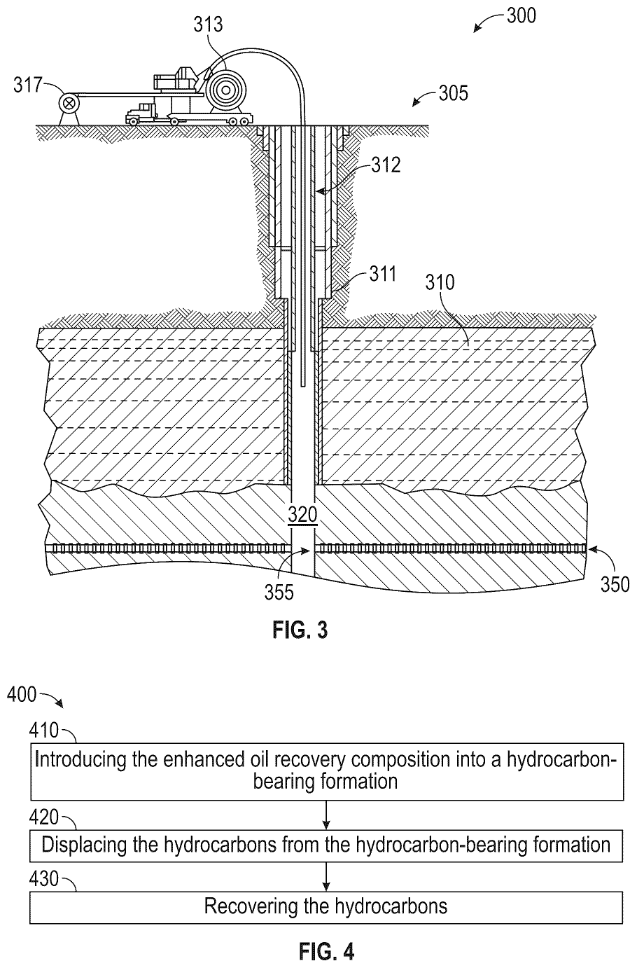

FIG. 3 depicts a well environment 300 in accordance with one or more embodiments. Well environment 300 includes a subsurface 310. Subsurface 310 is depicted having a wellbore wall 311 both extending downhole from a surface 305 into the subsurface 310 and defining a wellbore 320. The subsurface 310 also includes target formation 350 to be treated. Target formation 350 has target formation face 355 that fluidly couples target formation 350 with wellbore 320 through wellbore wall 311. In this case, casing 312 and coiled tubing 313 extend downhole through the wellbore 320 into the subsurface 310 and towards target formation 350. With the configuration in FIG. 3, the previously described embodiment that comprises the enhanced oil recovery composition may be introduced into the subsurface 310 and towards target formation 350 via a pump 317 through the coiled tubing 313.

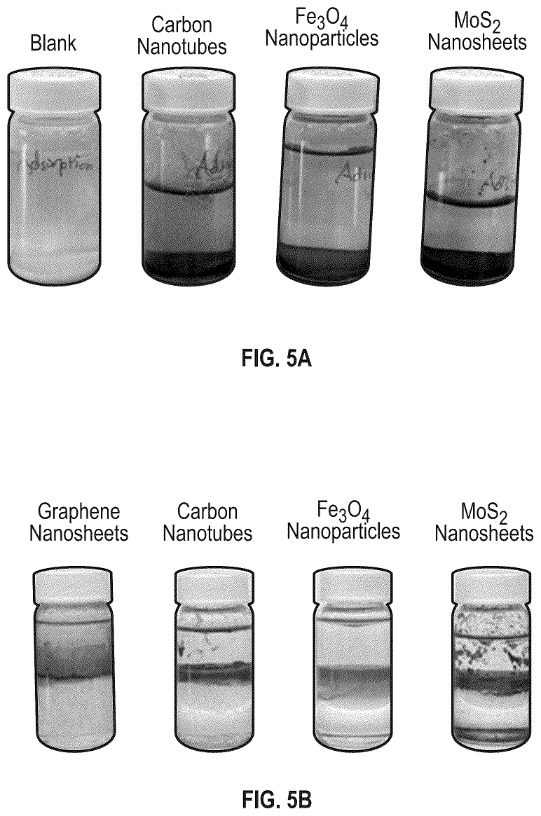

A method, 400, in accordance with the present disclosure is shown in, and discussed with reference to, FIG. 4. Initially, in step 410, an enhanced oil recovery composition is introduced into a hydrocarbon-bearing formation. In one or more embodiments, the EOR composition is introduced into the subsurface 310 of the target formation 350. The EOR nanofluid is as previously described. The hydrocarbon-bearing formation may include oil. In one or more embodiments, the hydrocarbon-bearing reservoir has already been depleted of about a third of its hydrocarbon content.

In method 400, step 420 includes displacing the hydrocarbons in the hydrocarbon-bearing foundation. The hydrocarbon may be displaced using the disclosed EOR composition. In one or more embodiments, the Janus nanomaterials may have a surfactant-like surface property in the EOR composition. Accordingly, disclosed Janus nanomaterials may reside at the oil-water interface or at the rock-fluid interface downhole, and thus may increase the hydrocarbon mobility or alter the wettability of reservoir rock, resulting in increased hydrocarbon displacement.

Step 430 in method 400 includes recovering the hydrocarbons. As described above, in the presence of the disclosed EOR composition, the hydrocarbons may have an increased mobility and thus an increased hydrocarbon recovery from the formation. Method 400 may result in greater recovery of oil initially in place (OIIP).

Embodiments of the present disclosure may provide at least one of the following advantages. Nanomaterials with asymmetric surface properties, i.e., Janus nanomaterials, may exhibit amphiphilic surfactant-like properties. The amphiphilic surfactant-like properties may allow for the nanomaterials to achieve a much higher efficiency in oil recovery with very low concentration of loading, when compared to homogeneous nanomaterial fluids.

### EXAMPLES

### Example 1: Janus Iron Oxide Nanoparticles (“Janus-Fe₃O₄”)

2 grams of chitosan powder (Alfa Aesar, 85% deacetylated, particles in ˜10-50 μm) was washed by ethanol and water and then redispersed in 50 mL of deionized (DI) water. Superparamagnetic iron oxide nanoparticles (SPIONs), i.e., magnetite Fe₃O₄ nanoparticles, with average size of ˜12 nm were synthesized by precipitating Fe²⁺ and Fe³⁺ ions in 1:2 molar ratio by concentrated ammonia (NH₃·H₂O) solution (29.5 wt %). The formed Fe₃O₄ nanoparticles were separated and collected by a magnet. 0.2 grams of the SPIONs were added to the chitosan suspension under stirring to allow full adsorption of the Fe₃O₄ nanoparticles on chitosan. The chitosan particles with adsorbed SPIONs were separated from the supernatant of the excess un-adsorbed Fe₃O₄ nanoparticles, and then redispersed in 50 mL water-ethanol (1:2 volume ratio) mixture with 1 mL NH₃·H₂O (29.5 wt %). 0.5 mL of octadecyltriethoxysilane (OTES, purity 92%, Gelest inc.) was added to the suspension and reacted with the nanoparticles under stirring. Upon the completion of the hydrolysis reaction with silane, hydrophobic octadecyl groups —(CH₂)₁₇—CH₃ were chemically grafted onto one side of the nanoparticles in solution. The chitosan particles with functionalized nanoparticles on the surface were separated and redispersed into a HCl solution (pH˜3) under ultrasonication. The chitosan particles were dissolved and the adsorbed Fe₃O₄ nanoparticles were released into solution. The asymmetrically functionalized Janus SPIONs were separated for further application.

### Example 2: Janus Carbon Nanotubes (“Janus-CNTs”)

2 grams of chitosan powder (Alfa Aesar, 85% deacetylated, particles in ˜10-50 μm) was washed by ethanol and water and then redispersed in 50 mL of DI water. 0.1 grams of oxidized carbon nanotubes (CNTs, surface functional group-OH, Alfa Chemicals, purity 95%) were added to the chitosan suspension under stirring to allow full adsorption of the CNTs on chitosan. The chitosan particles with adsorbed CNTs were separated from the supernatant of the excess un-adsorbed CNTs, and then redispersed in 50 mL water-ethanol (1:2 volume ratio) mixture with 1 mL NH₃·H₂O (29.5 wt %). 0.5 mL of dodecyltriethoxysilane (DTES, Gelest) was added to the suspension and reacted with the CNTs under stirring. Upon the completion of the hydrolysis reaction with silane, hydrophobic dodecyl groups were chemically grafted onto one side of the CNTs in solution. The chitosan particles with functionalized CNTs on the surface were separated and redispersed into an HCl solution (PH˜3) under ultrasonication. The chitosan particles were dissolved and released the adsorbed CNTs into solution. The asymmetrically functionalized Janus CNTs were separated for further application.

### Example 3: Janus Graphene Nanosheets (“Janus-GNSs”)

2 grams of chitosan powder (Alfa Aesar, 85% deacetylated, particles in ˜ 10-50 μm) was washed by ethanol and water and then redispersed in 50 mL of DI water. 0.1 grams of oxidized graphene nanosheets (GNSs) (TCI, graphene oxide) were added to the chitosan suspension under stirring to allow full adsorption of the GNSs on the chitosan. The chitosan particles with adsorbed GNSs were separated from the supernatant of the excess un-adsorbed GNSs, and then redispersed in 50 mL water-ethanol (1:2 volume ratio) mixture with 1 mL NH₃·H₂O (29.5 wt %). 0.5 mL of p-Tolyltriethoxysilane (p-TTES, purity 97%, Ambeed, Inc.) was added to the suspension and reacted with the GNSs under stirring. Upon the completion of the hydrolysis reaction with silane, hydrophobic groups —C₄H₆—CH₃ were chemically grated onto one side of the GNSs in solution. The chitosan particles with functionalized GNSs on the surface were separated and redispersed into a HCl solution (pH˜3) under ultrasonication. The chitosan particles were dissolved and released the adsorbed GNSs into solution. The asymmetrically functionalized Janus GNs were separated for further application.

### Example 4: Janus Molybdenum Sulfide Nanosheets (“Janus-MoS₂”)

2 grams of chitosan powder (Alfa Aesar, 85% deacetylated, particles in ˜10-50 μm) was washed by ethanol and water and then redispersed in 50 mL of DI water. 0.1 grams of molybdenum disulfide nanosheets (MoS₂-NSs, Aldrich, nanoplatelets) were added to the chitosan suspension under stirring to allow full adsorption of the MoS₂-NSs on the chitosan. The chitosan particles with adsorbed MoS₂-NSs were separated from the supernatant of the excess un-adsorbed MoS₂-NSs, and then redispersed in 50 mL water-ethanol (1:2 volume ratio) mixture with 1 mL NH₃·H₂O (29.5 wt %). 0.5 mL of 1H, 1H,2H,2H-Perfluorooctyltriethoxysilane (PFOTES, purity 98%, Sigma-Aldrich) was added to the suspension and reacted with the MoS₂-NSs under stirring. Upon the completion of the hydrolysis reaction with silane, hydrophobic groups —(CH₂)₂—(CF₂)₅—CF₃ were chemically grafted onto one side of the MoS₂-NSs in solution. The chitosan particles with functionalized MoS₂-NSs on surface were separated and redispersed into a HCl solution (pH˜3) under ultrasonication. The chitosan particles were dissolved and released the adsorbed MoS₂-NSs into solution. The asymmetrically functionalized Janus MoS₂-NSs were separated for further application.

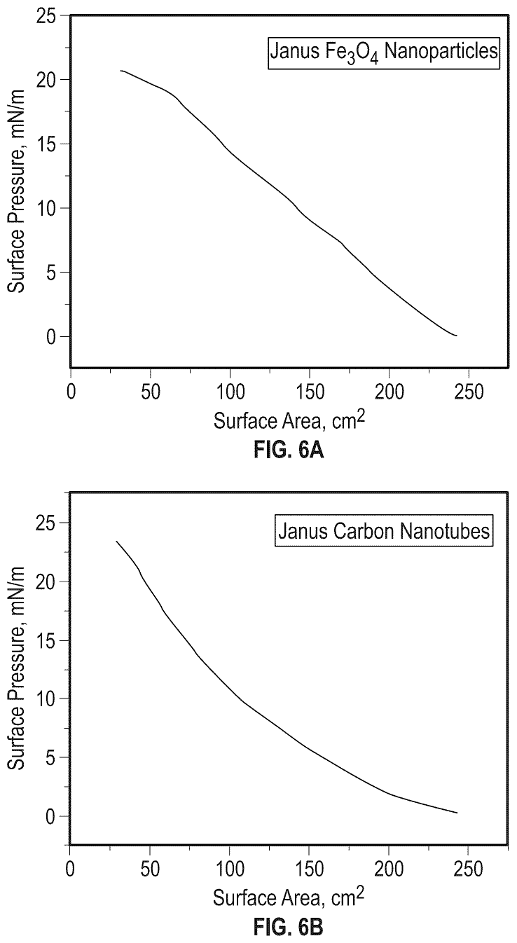

The image in FIG. 5A shows examples of a few typical nanomaterials adsorbed on chitosan particles. When superparamagnetic magnetite (Fe₃O₄) nanoparticles, multi-wall carbon nanotubes (MWNTs), graphene nanosheets (GNSs) and molybdenum sulfide (MoS₂) nanosheets were mixed with chitosan suspension water at neutral pH value, these nanomaterials could rapidly adsorb onto the chitosan surface, as evidenced by the clear supernatants in FIG. 5A. In FIG. 5A, the upper phase is a hexane solvent while the lower phase is water.

The image in FIG. 5B shows that after the asymmetric functionalization of the nanomaterials and release from the chitosan, the Janus nanomaterials tend to assemble at the interface of water-organic solvent to form interfacial thin films, which exhibit clear amphiphilic properties, i.e., surfactant-like nanoparticulate interfacial properties. In FIG. 5B, the upper phase is a hexane solvent while the lower phase is water. The Janus nanomaterials are seen as assembling between the layers of the upper phase and the lower phase.

Surface properties of synthesized Janus nanomaterials were characterized by Langmuir-Blodgett technology. When the synthesized Janus nanomaterials in ethanol suspension were dropped on water in a Langmuir trough, the amphiphilic Janus nanoparticles, nanotubes or nanosheets spread on the water surface to form a thin particulate film. When applying a lateral pressure on the surface, the Janus nanomaterials were compressed and caused an increase of the surface pressure, while the unfunctionalized hydrophilic nanomaterials entered the water subphase. The measurements were conducted with a KSV-NIMA Langmuir-Blodgett system at room temperature.

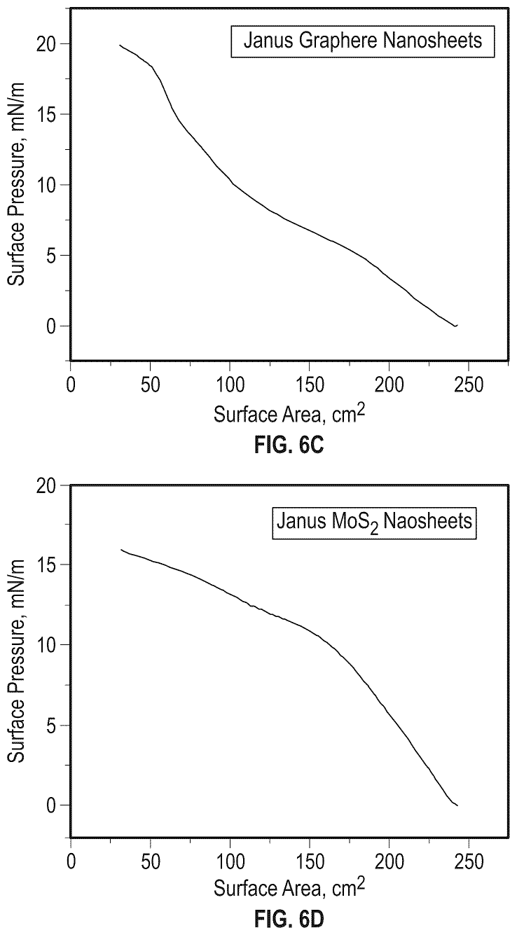

FIGS. 6A-D are example Langmuir isotherms of the Janus nanomaterials. As shown by the Langmuir isotherms, (also known as surface pressure (π)-Surface area (A) curves) all the synthesized Janus-Fe₃O₄ nanoparticles (FIG. 6A), Janus-carbon nanotubes (FIG. 6B), Janus-graphene nanosheets (FIG. 6C), and Janus-MoS₂ nanosheets (FIG. 6D) reached a significant surface pressure greater than 15 milliNewtons per meter (mN/m) on water. A surface pressure greater than 15 nM/m is typical for materials with amphiphilic properties, i.e., surfactant-like properties.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method of preparing a Janus nanomaterial, the method comprising:
dispersing a chitosan template in an aqueous solution;
adsorbing a first portion of a surface of a nanomaterial on the chitosan template;
functionalizing a second portion of the surface of the nanomaterial so that the second portion comprises a hydrophobic surface functionality; and
releasing the nanomaterial from the chitosan template, thereby providing the nanomaterial with asymmetric surface functionalities wherein the first portion comprises a hydrophilic surface functionality and the second portion comprises the hydrophobic surface functionality.

2. The method of claim 1 wherein the nanomaterial is selected from the group consisting of 0-dimensional nanoparticles, 1-dimensional nanotubes, 1-dimensional nanorods, 1-dimensional nanowires, 2-dimensional nanosheets, and combinations thereof.

3. The method of claim 1, wherein a weight ratio of the chitosan template to nanomaterial is in a range of 1:0.0001 to 0.01:1.

4. The method of claim 2, wherein the 0-dimensional nanoparticles are selected from the group consisting of metal oxide nanoparticles, metal nanoparticles, metal chalcogenide nanoparticles, and combinations thereof.

5. The method of claim 4, wherein the metal oxide nanoparticles are selected from the group consisting of Fe₃O₄, Fe₂O₃, SiO₂, TiO₂, ZrO₂, Al₂O₃, ZnO, CeO₂, and combinations thereof.

6. The method of claim 4, wherein the metal nanoparticles are selected from the group consisting of Ag nanoparticles, Au nanoparticles, Pd nanoparticles, Pt nanoparticles, Ru nanoparticles, Rh nanoparticles, Fe nanoparticles, Co nanoparticles, Ni nanoparticles, Cu nanoparticles, and combinations thereof.

7. The method of claim 4, wherein the metal chalcogenide nanoparticles are selected from the group consisting of ZnS, CdS, CuS, HgS, ZnSe, CdSe, ZnTe, CdTe, and combinations thereof.

8. The method of claim 2, wherein the 1-dimensional nanotubes are selected from the group consisting of single-walled carbon nanotubes, multiwalled carbon nanotubes, Au or Ag nanorods or nanowires, TiO₂ nanowires, ZnS, CuS, CdS, ZnSe, CuSe, CdSe, ZnTe, CuTe, or CdTe nanorods, ZnO, TiO₂, SnO₂, CeO₂, or WO₃ oxide nanobelts, and combinations thereof.

9. The method of claim 2, wherein the 2-dimensional nanosheets are selected from the group consisting of graphene nanosheets, molybdenum sulfide nanosheets, metal nanosheets, and combinations thereof.

10. The method of claim 9, wherein the metal nanosheets are selected from the group consisting of Cu, Ag, Au, Pd, Pt, and combinations thereof.

11. The method of claim 1, wherein the aqueous solution has a pH greater than or equal to 6.5.

12. The method of claim 1, wherein the hydrophobic surface functionality is provided by a chemical agent.

13. The method of claim 12, wherein the chemical agent is added at a weight ratio in a range of 0.01:1 to 1:1 of chemical agent to the nanomaterial.

14. The method of claim 12, wherein the chemical agent is a silane coupling agent with a hydrophobic functional group.

15. The method of claim 14, wherein the silane coupling agent has a formula:
$${( {R}^{I} O )}_{3} - Si - {OR}^{II}$$
wherein R^{I} is —(CₙH₂ₙ₊₁)₃, n=1-4; and R^{II} is selected from the group consisting of —(CH₂)ₘ—CH₃, m=7-17; —(CH₂)ₚ—NH₂, p=7-17; cycloalkyl, heteroaryl, alkoxy, aminoacyl, cycloalkenyl, heteroaryloxy, heterocyclooxy, and combinations thereof.

16. The method of claim 1, wherein releasing the nanomaterial from the chitosan template comprises adjusting a pH of the aqueous solution to a pH in a range of less than 4.5.

17. A method of enhanced oil recovery comprising:
introducing an enhanced oil recovery fluid into a hydrocarbon-bearing formation, wherein the enhanced oil recovery fluid comprises Janus nanomaterials as prepared in claim 1;
displacing hydrocarbons from the hydrocarbon-bearing formation; and
recovering the hydrocarbons.

18. The method of claim 17, wherein the Janus nanomaterials are present in the enhanced oil recovery fluid an amount from 0.01 to 3 wt %.

19. The method of claim 17, wherein the enhanced oil recovery fluid further comprises an aqueous-based fluid.

20. The method of claim 19, wherein the aqueous-based fluid comprises one or more additives selected from the group consisting of surfactants, stabilizers, and combinations thereof.
